(19) United States
(12) Patent Application Publication
(10) Pub. No.: US 2016/0346795 A1
(43) Pub. Date: Dec. 1, 2016

(54) NOZZLE, SUBSTRATE TREATING APPARATUS INCLUDING THE SAME, AND SUBSTRATE TREATING METHOD

(71) Applicant: Semes Co., Ltd., Cheonan-si (KR)

(72) Inventors: Kihoon CHOI, Cheonan-si (KR); Yoon Jong Ju, Cheonan-si (KR); Byung Man Kang, Cheonan-si (KR)

(73) Assignee: Semes Co., Ltd., Cheonan-si (KR)

(21) Appl. No.: 15/160,136

(22) Filed: May 20, 2016

(30) Foreign Application Priority Data
May 29, 2015 (KR) 10-2015-0076229

(51) Int. Cl. B05B 1/08; B08B 3/02; B08B 3/08; B05B 1/18; B08B 3/10

(52) U.S. Cl. CPC B05B 1/083; B05B 1/18; B08B 3/102; B08B 3/08; B08B 3/02

(57) ABSTRACT

Disclosed is a nozzle for supplying a treatment liquid to a substrate, the nozzle including a body having a passage, through which the treatment liquid flows, in the interior thereof, and having a discharge hole communicated with the passage and through which the treatment liquid is discharged, and a piezoelectric element that pressurize the treatment liquid flowing through the body to discharge the treatment liquid through the discharge hole in a state of droplets, wherein an average diameter of the droplets discharged through the discharge hole is equal to or greater than 5 micrometers and is less than 15 micrometers.

### CROSS-REFERENCE TO RELATED APPLICATIONS

A claim for priority under 35 U.S.C. §119 is made to Korean Patent Application No. 10-2015-0076229 filed May 29, 2015, in the Korean Intellectual Property Office, the entire contents of which are hereby incorporated by reference.

### BACKGROUND

The inventive concept relates to a nozzle that supplies a treatment liquid, a substrate treating apparatus including the same, and a substrate treating method.

In order to manufacture a semiconductor device or a liquid crystal display, various processes such as photolithography, etching, ashing, ion implantation, and thin film deposition are performed on a substrate. In order to eliminate foreign substances and particles produced in the processes, a cleaning process of cleaning the substrate is carried out before or after the processes.

For the cleaning process, various methods of injecting chemicals, injecting a treatment liquid mixed with gases, or injecting a treatment liquid provided with vibration are used to eliminate foreign substances and particles on a substrate.

The method of injecting a treatment liquid by using vibrations in the cleaning process influences removal of foreign particles residing on the substrate according to the sizes of the particles.

When the sizes of the particles are not constant while the particles are supplied, the cleaning force is not constant and the efficiency of the cleaning process deteriorates.

### SUMMARY

The inventive concept provides a nozzle for improving the efficiency of the cleaning process, a substrate treating apparatus including the same, and a substrate treating method.

The inventive concept also provides a nozzle for making the size of particles of a treatment liquid supplied to a substrate constant, a substrate treating apparatus including the same, and a substrate treating method.

The inventive concept also provides a nozzle for preventing a treatment liquid supplied in a cleaning process from damaging a substrate, a substrate treating apparatus including the same, and a substrate treating method.

The problems that are to be solved by the inventive concept are not limited to the above-mentioned problems, and the unmentioned problems will be clearly understood by those skilled in the art to which the inventive concept pertains from the specification and the accompanying drawings.

The inventive concept provides a nozzle that supplies a treatment liquid to a substrate.

In accordance with an aspect of the inventive concept, there is provided a nozzle for supplying a treatment liquid to a substrate, the nozzle including a body having a passage, through which the treatment liquid flows, in the interior thereof, and having a discharge hole communicated with the passage and through which the treatment liquid is discharged, and a piezoelectric element that pressurize the treatment liquid flowing through the body to discharge the treatment liquid through the discharge hole in a state of droplets, wherein an average diameter of the droplets discharged through the discharge hole is equal to or greater than 5 micrometers and is less than 15 micrometers.

According to an embodiment, the piezoelectric element may apply a frequency that makes a ratio (λ/d) of a distance (λ) between droplets discharged through the discharge hole to the diameter (d) of the discharge hole 3.5 to 6 to the treatment liquid flowing through the passage.

According to an embodiment, the diameter of the discharge hole may be 2 micrometers to 8 micrometers.

According to an embodiment, the treatment liquid flowing through the passage and the discharge hole may have a form of laminar flows.

According to an embodiment, the treatment liquid may have a viscosity and a density that makes the Reynold's number 700 or less while being discharged through the discharge hole.

The inventive concept provides an apparatus for treating a substrate.

In accordance with an aspect of the inventive concept, there is provided an apparatus for treating a substrate, the apparatus including a container having a treatment space in the interior thereof, a support unit located in the treatment space and on which the substrate is positioned, and a nozzle that supplies a treatment liquid to the substrate positioned on the support unit, wherein the nozzle includes a body having a passage, through which the treatment liquid flows, in the interior thereof, and having a discharge hole communicated with the passage and through which the treatment liquid is discharged, and a piezoelectric element that pressurize the treatment liquid flowing through the body to discharge the treatment liquid through the discharge hole in a state of droplets, and wherein an average diameter of the droplets discharged through the discharge hole is equal to or greater than 5 micrometers and is equal to or less than 15 micrometers.

According to an embodiment, the piezoelectric element may apply a frequency that makes a ratio (λ/d) of a distance (λ) between droplets discharged through the discharge hole to the diameter (d) of the discharge holes 3.5 to 6 to the treatment liquid flowing through the passage.

According to an embodiment, the diameter of the discharge hole may 2 micrometers to 8 micrometers.

According to an embodiment, the treatment liquid flowing through the passage and the discharge hole may have a form of laminar flows.

According to an embodiment, the treatment liquid may have a viscosity and a density that makes the Reynold's number 700 or less while being discharged through the discharge hole.

The inventive concept provides a method for treating a substrate.

In accordance with an aspect of the inventive concept, there is provided a method for treating a substrate, the method including applying a frequency to a treatment liquid flowing through a body such that the treatment liquid is supplied to the substrate in a state of droplets through a discharge hole formed in the body, wherein an average diameter of the droplets discharged through the discharge hole is equal to or greater than 5 micrometers and is less than 15 micrometers.

According to an embodiment, the piezoelectric element may apply a frequency that makes a ratio (λ/d) of a distance (λ) between droplets discharged through the discharge hole to the diameter (d) of the discharge holes 3.5 to 6 to the treatment liquid flowing through the passage.

According to an embodiment, the diameter of the discharge hole may be 2 micrometers to 8 micrometers.

According to an embodiment, the treatment liquid flowing through the passage and the discharge hole may have a form of laminar flows.

According to an embodiment, the treatment liquid may have a viscosity and a density that makes the Reynold's number 700 or less while being discharged through the discharge hole.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a plan view schematically illustrating a substrate treating system according to an embodiment of the inventive concept;

FIG. 2 is a sectional view illustrating a substrate treating apparatus of FIG. 1;

FIG. 3 is a sectional view illustrating a nozzle of FIG. 2;

FIG. 4 is a bottom view illustrating the nozzle of FIG. 3;

FIG. 5 is a view illustrating another embodiment of an injection passage of the nozzle of FIG. 2.

FIG. 6 is a view illustrating droplets discharged from the nozzle of FIG. 2; and

FIG. 7 is a view schematically illustrating that a liquid flows in the interior of the nozzle of FIG. 2.

### DETAILED DESCRIPTION

Hereinafter, exemplary embodiments of the inventive concept will be described in more detail with reference to the accompanying drawings. The embodiments of the inventive concept may be modified in various forms, and the scope of the inventive concept should not be construed to be limited to the following embodiments. The embodiments of the inventive concept are provided to describe the inventive concept for those skilled in the art more completely. Accordingly, the shapes of the components of the drawings are exaggerated to emphasize clearer description thereof.

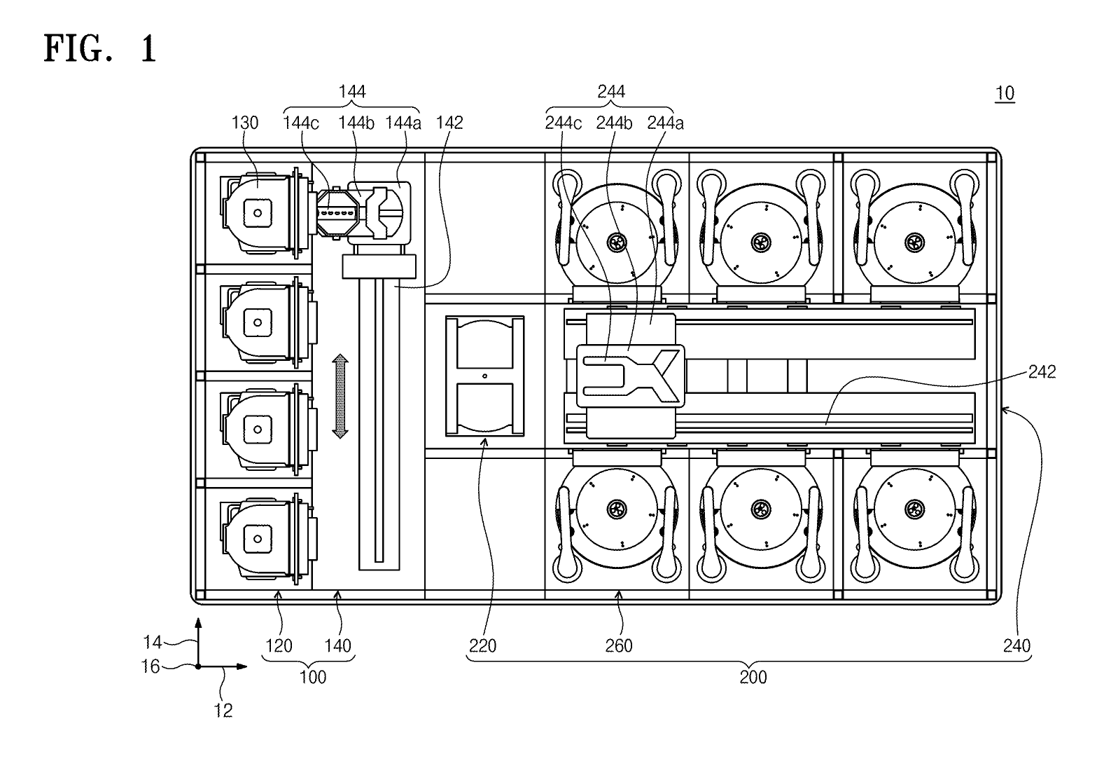

FIG. 1 is a plan view schematically illustrating a substrate treating system according to an embodiment of the inventive concept. Referring to FIG. 1, the substrate treating system 1 includes an index module 10 and a process treating module 20. The index module 10 includes a plurality of load ports 120 and a feeding frame 140. The load ports 120, the feeding frame 140, and the process treating module 20 may be sequentially arranged in a row. Hereinafter, a direction in which the load ports 120, the feeding frame 140, and the process treating module 20 are arranged will be referred to as a first direction 12, a direction that is perpendicular to the first direction 12 when viewed from the top will be referred to as a second direction 14, and a direction that is normal to a plane containing the first direction 12 and the second direction 14 will be referred to as a third direction 16.

A carrier 130, in which a substrate W is received, is seated on the load port 140. A plurality of load ports 120 are provided. The plurality of load ports 140 are arranged in a row along the second direction 14. The number of the load ports 120 may be increased or decreased according to the process efficiency of the process treating module 20, a footprint condition, and the like. A plurality of slots (not illustrated) for receiving substrates W while the substrates W are arranged in parallel to the ground surface are formed in the carrier 130. A front opening unified pod (FOUP) may be used as the carrier 130.

The process treating module 20 includes a buffer unit 220, a feeding chamber 240, and a plurality of process chambers 260. The feeding chamber 240 is arranged such that the lengthwise direction thereof is in parallel to the first direction 12. The process chambers 260 are arranged on opposite sides of the feeding chamber 240. The process chambers 260 are provided on the opposite sides of the feeding chamber 240 to be symmetrical to each other with respect to the feeding chamber 240. A plurality of process chambers 260 are arranged on one side of the feeding chamber 240. Some of the process chambers 260 are arranged along the lengthwise direction of the feeding chamber 240. Furthermore, some of the process chambers 260 are arranged to be stacked on each other. That is, the process chamber 260 having an array of A by B may be arranged on one side of the feeding chamber 240. Here, A is the number of the process chambers 260 provided in a row along the first direction 12, and B is the number of the process chambers 260 provided in a row along the third direction 16. When four or six process chambers 260 are provided on one side of the feeding chamber 240, the process chambers 260 may be arranged in an array of 2 by 2 or 3 by 2. The number of the process chambers 260 may increase or decrease. Unlike the above-mentioned description, the process chambers 260 may be provided only on one side of the feeding chamber 240. Selectively, the process chambers 260 may be provided on one side or opposite sides of the feeding chamber 240 to form a single layer.

A buffer unit 220 is arranged between the feeding frame 140 and the feeding chamber 240. The buffer unit 220 provides a space in which the substrates W stay before being transported, between the feeding chamber 240 and the feeding frame 140. A plurality of slots (not illustrated) in which the substrates W are positioned are provided in the interior of the buffer unit 220. A plurality of slots (not illustrated) may be provided to be spaced apart from each other along the third direction 16. A face of the buffer unit 220 that faces the feeding frame 140 and a face of the buffer unit 220 that faces the feeding chamber 240 are opened.

The feeding frame 140 transports the substrates W between the carrier 130 seated on the load port 120 and the buffer unit 220. An index rail 142 and an index robot 144 are provided in the feeding frame 140. The index rail 142 is arranged such that the lengthwise direction thereof is in parallel to the second direction 14. The index robot 144 is installed on the index rail 142, and is linearly moved in the second direction 14 along the index rail 142. The index robot 144 has a base 144a, a body 144b, and a plurality of index arms 144c. The base 144a is installed to be moved along the index rail 142. The body 144b is coupled to the base 144a. The body 144b is provided to be moved along the third direction 16 on the base 144a. The body 144b is provided to be rotated on the base 144a. The index arms 144c are coupled to the body 144b, and are provided to be moved forwards and rearwards with respect to the body 144b. A plurality of index arms 144c are provided to be driven individually. The index arms 144c are arranged to be stacked so as to be spaced apart from each other along the third direction 16. Some of the index arms 144c are used when the substrates W are transported to the carrier 130 in the process treating module 20, and some of the index arms 144c may be used when the substrates W are transported from the carrier 130 to the process treating module 20. This structure may prevent particles generated from the substrates W before the process treatment from being attached to the substrates W after the process treatment in the process of carrying the substrates W in and out by the index robot 144.

The feeding chamber 240 transports the substrates W between the buffer unit 220 and the process chambers 260, and between the process chambers 260. A guide rail 242 and a main robot 244 are provided in the feeding chamber 240. The guide rail 242 is arranged such that the lengthwise direction thereof is in parallel to the first direction 12. The main robot 244 is installed on the guide rail 242, and is linearly moved along the first direction 12 on the index rail 242. The main robot 244 has a base 244a, a body 244b, and a plurality of main arms 244c. The base 244a is installed to be moved along the guide rail 242. The body 244b is coupled to the base 244a. The body 244b is provided to be moved along the third direction 16 on the base 244a. The body 244b is provided to be rotated on the base 244a. The main arms 244c are coupled to the body 244b, and are provided to be moved forwards and rearwards with respect to the body 244b. A plurality of main arms 244c are provided to be driven individually. The main arms 244c are arranged to be stacked so as to be spaced apart from each other along the third direction 16.

Substrate treating apparatuses 300 that perform cleaning processes on the substrates W are provided in the process chambers 260. The substrate treating apparatus 300 may have different structures according to the types of the cleaning processes. Alternatively, the substrate treating apparatuses 300 in the process chambers 260 may have the same structure. Selectively, the process chambers 260 may be classified into a plurality of groups such that the structures of the substrate treating apparatuses 300 in the process chambers 260 pertaining to the same group are the same and the structures of the substrate treating apparatuses 300 in the process chambers 260 pertaining to different groups are different.

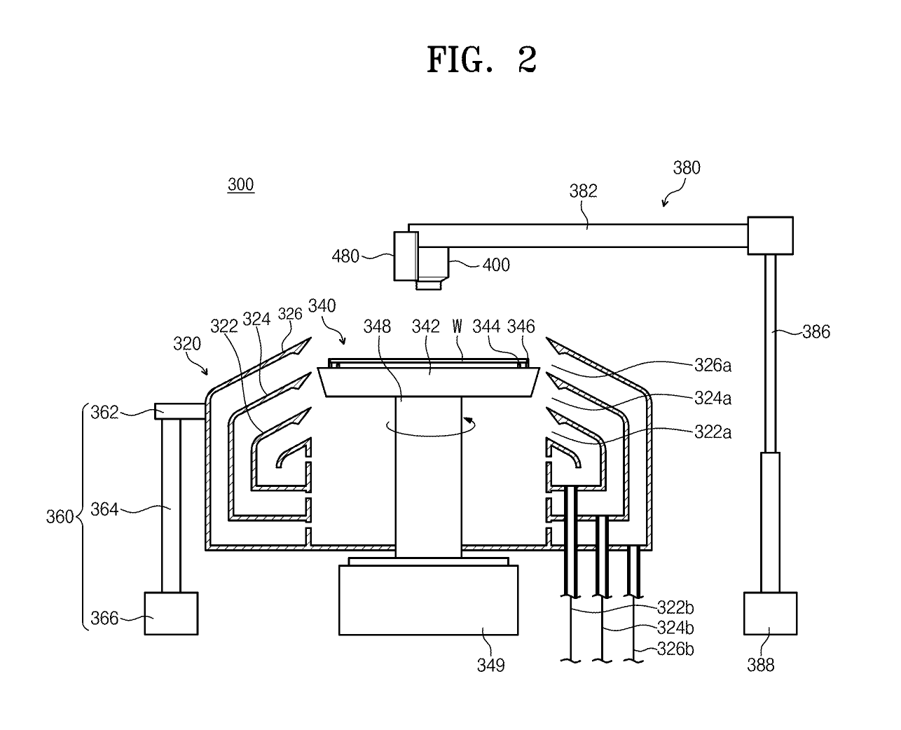

FIG. 2 is a sectional view illustrating a substrate treating apparatus of FIG. 1.

Referring to FIG. 2, the substrate treating apparatus 300 includes a container 320, a support unit 340, an elevation unit 360, and an injection unit 380. The container 320 has a treatment space in the interior thereof. The treatment space is a space in which a substrate treating process is performed. The upper side of the container 320 is opened. The container 320 has an inner recovery vessel 322, an intermediate recovery vessel 324, and an outer recovery vessel 326. The recovery vessels 322, 324, and 326 recover different treatment liquids used in the process. The inner recovery vessel 322 is provided to have an annular ring shape that surrounds the support unit 340. The intermediate recovery vessel 324 is provided to have an annular ring shape that surrounds the inner recovery vessel 322. The outer recovery vessel 326 is provided to have an annular ring shape that surrounds the intermediate recovery vessel 324. An inner space 322a of the inner recovery vessel 322, a space 324a between the inner recovery vessel 322 and the intermediate recovery vessel 324, and a space 326a between the intermediate recovery vessel 324 and the outer recovery vessel 326 function as inlets through which the treatment liquids are introduced into the inner recovery vessel 322, the intermediate recovery vessel 324, and the outer recovery vessel 326. Recovery lines 322b, 324b, and 326b extending from the recovery vessels 322, 324, and 326 perpendicularly in the downward direction of the bottom surfaces thereof are connected to the recovery vessels 322, 324, and 326, respectively. The recovery lines 322b, 324b, and 326b discharge the treatment liquids introduced through the recovery vessels 322, 324, 326, respectively. The discharged treatment liquids may be reused through an external treatment liquid recycling system (not illustrated).

The support unit 340 supports and rotates the substrate W during the process. The support unit 340 has a body 342, a plurality of support pins 344, a plurality of chuck pins 346, and a support shaft 348. The body 342 has an upper surface having a substantially circular shape when viewed from the top. The support shaft 348 that may be rotated by a motor 349 is fixedly coupled to the bottom of the body 342.

A plurality of support pins 344 are provided. The support pins 344 may be arranged to be spaced apart from each other at a periphery of the upper surface of the body 342 and protrude upwards from the body 342. The support pins 344 are arranged to have a generally annular ring shape through combination thereof. The support pins 344 support a periphery of a rear surface of the substrate W such that the substrate W is spaced apart from the upper surface of the body 342 by a predetermined distance.

A plurality of chuck pins 346 are provided. The chuck pins 346 are arranged to be more distant from the center of the body 342 than the support pins 344. The chuck pins 346 are provided to protrude upwards from the body 342. The chuck pins 346 support a side of the substrate W such that the substrate W is not separated laterally from a proper place when the support unit 340 is rotated. The chuck pins 346 are provided to be linearly moved between a standby position and a support position along a radial direction of the body 342. The standby position is a position that is more distant from the center of the body 342 than the support position. When the substrate W is loaded on or unloaded from the support unit 340, the chuck pins 346 are located at the standby position, and when a process is performed on the substrate W, the chuck pins 346 are located at the support position. The chuck pins 346 are in contact with the side of the substrate W at the support position.

The elevation unit 360 linearly moves the container 320 upwards and downwards. When the container 320 is moved upwards and downwards, a relative height of the container 320 to the support unit 340 is changed. The elevation unit 360 has a bracket 362, a movable shaft 364, and a driver 366. The bracket 362 is fixedly installed on an outer wall of the container 320, and the movable shaft 364 that is moved upwards and downwards by the driver 366 is fixedly coupled to the bracket 362. The container 320 is lowered such that, when the substrate W is positioned on the support unit 340 or is lifted from the support unit 340, the support unit 340 protrudes to the upper side of the container 320. When the process is performed, the height of the container 320 is adjusted such that the treatment liquid is introduced into the preset recovery vessel 360 according to the kind of the treatment liquid supplied to the substrate W. Selectively, the elevation unit 360 may move the support unit 340 upwards and downwards.

The injection unit 380 injects the treatment liquid onto the substrate W. A plurality of injection units 380 may be provided to inject various kinds of treatment liquids or the same kind of treatment liquid in various methods. The injection unit 380 includes a support shaft 386, a nozzle arm 382, a nozzle 400, and a nozzle member 480.

The support shaft 386 is arranged on one side of the container 320. The support shaft 386 has a rod shape, of which a lengthwise direction is a vertical direction. The support shaft 386 is swung and elevated by the driver member 388. Unlike this, the support shaft 386 may be linearly moved horizontally and elevated by the driver member 388. A nozzle arm 382 is fixedly coupled to an upper end of the support shaft 386. The nozzle arm 382 supports the nozzle 400 and the nozzle member 480.

The nozzle 400 and the nozzle member 480 are situated at an end of the nozzle arm 382. For example, the nozzle member 480 may be situated closer to the end of the nozzle arm 382 than the nozzle 400.

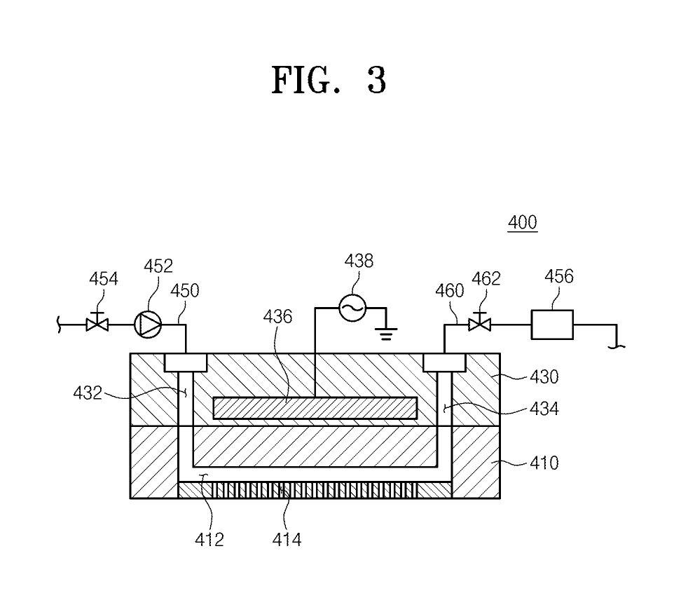

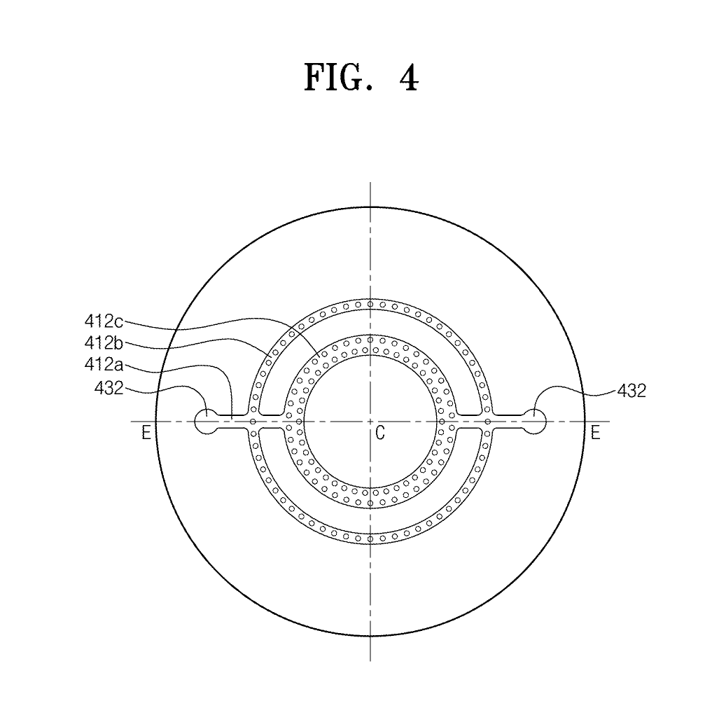

FIG. 3 is a sectional view illustrating a nozzle of FIG. 2. FIG. 4 is a bottom view illustrating the nozzle of FIG. 3. Referring to FIGS. 3 and 4, the nozzle 400 supplies a treatment liquid onto the substrate W. When viewed from the top, the nozzle 400 has a circular shape. The nozzle 400 includes a body 410,430, a piezoelectric element 436, a treatment liquid supply line 450, and a treatment liquid recovery line 460. The nozzle 400 discharges the treatment liquid in an inkjet method.

The body 410,430 has a lower plate 410 and an upper plate 430. The lower plate 410 has a cylindrical shape. A passage 412, through which the treatment liquid flows, is formed in the interior of the lower plate 410. The passage 412 connects an introduction passage 432 and a recovery passage 434. A plurality of discharge holes 414, through which the first treatment liquid is injected, are formed on the bottom surface of the lower plate 410, and the discharge holes 414 are communicated with the passage 412. The diameters of the discharge holes 414 may be 2 micrometers or 8 micrometers. Fine holes are formed in the discharge holes 414. The passage 412 may have a first area 412b, a second area 412c, and a third area 412a. When viewed from the top, the first area 412b and the second area 412c have ring shapes. The radius of the first area 412b is larger than the radius of the second area 412c. The discharge holes 414 of the first area 412b may be provided in a row along the first area 412b. The discharge holes 414 of the second area 412c may be provided in two rows along the second area 412c. The third area 412a connects the first area 412b and the second area 412c to an introduction passage 432. The third area 412a connects the first area 412b and the second area 412c to a recovery passage 434. For example, as illustrated in FIG. 4, the third area 412a may be connected to the introduction passage 432 or the recovery passage 434. The upper plate 430 has a cylindrical shape having the same diameter as that of the lower plate 410. The upper plate 430 is fixedly coupled to the upper surface of the lower plate 410. The introduction passage 432 and the recovery passage 434 are formed in the interior of the upper plate 430. The introduction passage 432 and the recovery passage 434 are communicated with the second area 412b of the passage 412. The introduction passage 432 functions as an inlet through which the treatment liquid is introduced into the passage 412, and the recovery passage 434 functions as an outlet through which the treatment liquid is recovered from the passage 412. The introduction passage 432 and the recovery passage 434 are situated to face each other with respect to the center of the nozzle 400.

The piezoelectric element 436 is situated in the interior of the upper plate 430. When viewed from the top, the piezoelectric element 436 has a disk shape. For example, the piezoelectric element 436 has the same diameter as that of the first area 412b. Selectively, the diameter of the piezoelectric element 436 may be larger than the diameter of the first area 412b and smaller than the diameter of the upper plate 430. The piezoelectric element 436 is electrically connected to a power source 438 situated on the outside. The piezoelectric element 436 provides vibration for the injected treatment liquid to control the size of particles and the flow rate of the treatment liquid.

A frequency is applied to the treatment liquid by the piezoelectric element 436 such that a ratio (λ/d) of a distance (λ) between the droplets discharged through the discharge hole 414 to a diameter (d) of the discharge hole 414 is 3.5 to 6. The treatment liquid is provided as a cleaning liquid. For example, the treatment liquid may be electrolyzed water. The treatment liquid may include any one or all of hydrogen water, oxygen water, or ozone water. Selectively, the treatment liquid may be pure water.

The treatment liquid supply line 450 supplies the treatment liquid to the introduction passage 432, and the treatment liquid recovery line 460 recovers the treatment liquid from the recovery passage 434. The treatment liquid supply line 450 is connected to the introduction passage 432. The treatment liquid recovery line 460 is connected to the recovery passage 434. A pump 452 and a supply valve 454 are installed on the treatment liquid supply line 450. A recovery valve 462 is installed on the treatment liquid recovery line 460. The pump 452 pressurizes the treatment liquid supplied from the treatment liquid supply line 450 to the introduction passage 432. The supply valve 454 opens and closes the treatment liquid supply line 450. The recovery valve 462 opens and closes the treatment liquid recovery line 460. According to an embodiment, when the process is in a standby state, the recovery valve 462 opens the treatment liquid recovery line 460. Accordingly, the treatment liquid is recovered through the treatment liquid recovery line 460, and is not injected through the discharge holes 414. Differently, while the process is performed, the recovery valve 462 closes the treatment liquid recovery line 460. Accordingly, the passage 412 is filled with the treatment liquid and the internal pressure of the passage 412 increases, and if an electric voltage is applied to the piezoelectric element 436, the treatment liquid may be injected through the discharge holes 414. The average diameter (d1 to d5) of the droplets supplied through the discharge hole 414 is equal to or greater than 5 micrometers and less than 15 micrometers.

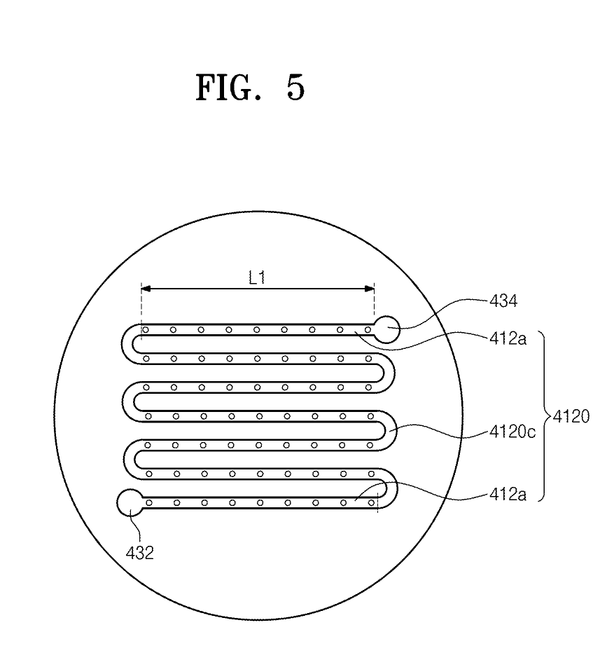

FIG. 5 is a view illustrating another embodiment of a passage of the nozzle of FIG. 2. Hereinafter, referring to FIG. 5, the passage 4120 includes a first passage 4120a, a second passage 4120b, and a third passage 4120c. The first passage 4120a extends from the introduction passage 432. The first passage 4120a may have a first length L1. The second passage 4120b extends from the recovery passage 434. The second passage 4120b is provided in parallel to the first passage 4120a. The second passage 4120b may have a first length L1. The third passage 4120c connects the first passage 4120a and the second passage 4120b. The third passage 4120c is curved. A portion of the third passage 4120c may be parallel to the first passage 4120a and may have a first length L1. For example, the third passage 4120c may be provided to have a shape in which a plurality of U shapes are connected to each other. Selectively, the third passage 4120c may have various shapes.

Referring back to FIG. 2, the nozzle member 480 supplies a protective liquid onto the substrate W. The nozzle member 480 supplies a protective liquid when the nozzle 400 supplies a treatment liquid. Then, the nozzle member 480 may supply the protective liquid first before the nozzle 400 starts to supply the treatment liquid. For example, the nozzle member 480 may inject the protective liquid in a drop manner. The nozzle member 480 surrounds a part of the nozzle 400. The nozzle member 480 is provided more adjacent to one end of the nozzle arm 382 than the nozzle 400. The nozzle member 480 has first discharge hole (not illustrated) through which the protective liquid is discharged onto the substrate W perpendicularly to the substrate W. The nozzle member 480 has an arc shape that surrounds a portion of the nozzle 400 when viewed from the top. A linear distance between the opposite ends of the nozzle member 480 may be greater than the diameter of the nozzle 400. Then, the nozzle 400 and the nozzle member 480 may be concentric. For example, the protective liquid may be a solution containing ammonia and hydrogen peroxide. The protective liquid forms a liquid film on the substrate W, and the liquid film alleviates an impact applied to the substrate W by the treatment liquid. Accordingly, the pattern on the substrate W can be prevented from being fallen by the treatment liquid. The protective liquid may be pure water. The first discharge hole may be provided to have a single slit shape. Selectively, the first discharge hole may include a plurality of circular discharge holes. The nozzle member 480 may inject the protective liquid to an area adjacent to the area of the substrate W, to which the treatment liquid is injected. The area, to which the protective liquid is injected, may be closer to a central area of the substrate W than the area, to which the treatment liquid is injected. Selectively, the nozzle member 480 may have a bar shape instead of an arc shape.

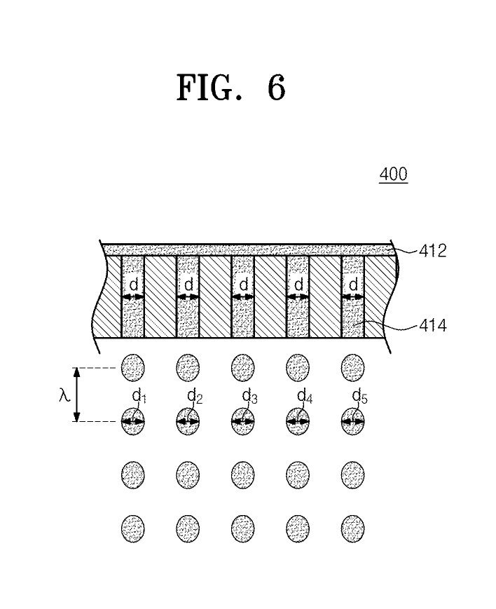

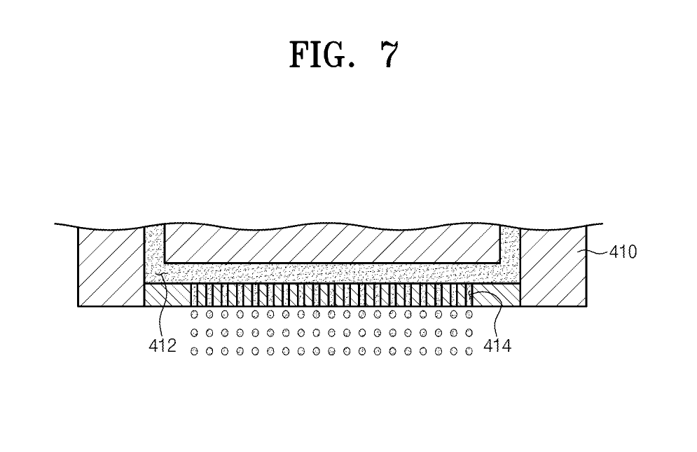

FIG. 6 is a view illustrating droplets discharged from the nozzle of FIG. 2. FIG. 7 is a view schematically illustrating that a liquid flows in the interior of the nozzle of FIG. 2. Referring to FIGS. 6 and 7, the nozzle 400 discharges the treatment liquid through the discharge hole 414 in the form of droplets. The plurality of discharge holes 414 supplies droplets of a uniform size onto the substrate W. The average diameter (d1 to d5) of the plurality of droplets discharged through the discharge hole 414 is equal to or greater than 5 micrometers and less than 15 micrometers.

In order to maintain the size of the droplets, a ratio (λ/d) of a distance (λ) between the droplets discharged through the discharge hole 414 to a diameter (d) of the discharge hole 414 is 3.5 to 6. A frequency is applied to the treatment liquid flowing through the passage 412 by the piezoelectric element such that a ratio (λ/d) of a distance (λ) between droplets discharged through the discharge hole 414 to a diameter (d) of the discharge hole 414 may be maintained. The treatment liquid flowing through the passage 412 is discharged through the discharge hole 414 after a frequency is applied to the treatment liquid. Then, the average diameter (d1 to d5) of the discharged droplets is equal to or greater than 5 micrometers and less than 15 micrometers.

The treatment liquid flowing through the passage 412 and the discharge hole 414 is provided in the form of laminar flows. Because the treatment liquid flowing through the passage 412 and the discharge hole 414 is provided in the form of laminar flows, the sizes of the droplets discharged through the discharge hole 414 may be uniform. When the treatment liquid is discharged through the discharge hole 414, the Reynold's number is equal to or less than 700. To achieve this, the treatment liquid has a viscosity and a density that make the Reynold's number 700 or less.

According to an embodiment of the inventive concept, a constant physical cleaning force may be transferred to the substrate W by droplets of the treatment liquid supplied onto the substrate W such that the droplets have a constant fine size. The droplets may have a constant size to improve the efficiency of the cleaning process. Further, the treatment liquid may be supplied onto the substrate W while the droplets maintaining a constant size, so that the damage to the substrate W may be reduced and the efficiency of the cleaning process may be improved.

According to an embodiment of the inventive concept, the efficiency of a substrate cleaning process may be improved by making the size of a treatment liquid supplied by a nozzle constant.

Further, according to an embodiment of the inventive concept, a damage applied to a substrate when a treatment liquid is supplied to the substrate in a substrate cleaning process may be reduced by making the sizes of the treatment liquid supplied to the substrate small.

Furthermore, according to an embodiment of the inventive concept, the efficiency of a substrate cleaning process may be improved by making the sizes of a treatment liquid supplied by a nozzle uniform to provide a constant physical cleaning force.

The effects of the inventive concept are not limited to the above-mentioned effects, and the unmentioned effects can be clearly understood by those skilled in the art to which the inventive concept pertains from the specification and the accompanying drawings.

The above-mentioned detailed description exemplifies the inventive concept. Furthermore, the above-mentioned contents describe the exemplary embodiment of the inventive concept, and the inventive concept may be used in various other combinations, changes, and environments. That is, the inventive concept can be modified and corrected without departing from the scope of the inventive concept that is disclosed in the specification, the equivalent scope to the written disclosures, and/or the technical or knowledge range of those skilled in the art. The written embodiment describes the best state for implementing the technical spirit of the inventive concept, and various changes required in the detailed application fields and purposes of the inventive concept can be made. Accordingly, the detailed description of the inventive concept is not intended to restrict the inventive concept in the disclosed embodiment state. Furthermore, it should be construed that the attached claims include other embodiments.

What is claimed is:

1. A nozzle for supplying a treatment liquid to a substrate, the nozzle comprising:
a body having a passage, through which the treatment liquid flows, in the interior thereof, and having a discharge hole communicated with the passage and through which the treatment liquid is discharged; and
a piezoelectric element that pressurize the treatment liquid flowing through the body to discharge the treatment liquid through the discharge hole in a state of droplets,
wherein an average diameter of the droplets discharged through the discharge hole is equal to or greater than 5 micrometers and is less than 15 micrometers.

2. The nozzle of claim 1, wherein the piezoelectric element applies a frequency that makes a ratio (λ/d) of a distance (λ) between droplets discharged through the discharge hole to the diameter (d) of the discharge hole 3.5 to 6 to the treatment liquid flowing through the passage.

3. The nozzle of claim 1, wherein the diameter of the discharge hole is 2 micrometers to 8 micrometers.

4. The nozzle of claim 1, wherein the treatment liquid flowing through the passage and the discharge hole has a form of laminar flows.

5. The nozzle of claim 1, wherein the treatment liquid has a viscosity and a density that makes the Reynold's number 700 or less while being discharged through the discharge hole.

6. An apparatus for treating a substrate, the apparatus comprising:
a container having a treatment space in the interior thereof;
a support unit located in the treatment space and on which the substrate is positioned; and
a nozzle that supplies a treatment liquid to the substrate positioned on the support unit,
wherein the nozzle comprises:
a body having a passage, through which the treatment liquid flows, in the interior thereof, and having a discharge hole communicated with the passage and through which the treatment liquid is discharged; and
a piezoelectric element that pressurize the treatment liquid flowing through the body to discharge the treatment liquid through the discharge hole in a state of droplets, and
wherein an average diameter of the droplets discharged through the discharge hole is equal to or greater than 5 micrometers and is less than 15 micrometers.

7. The apparatus of claim 6, wherein the piezoelectric element applies a frequency that makes a ratio (λ/d) of a distance (λ) between droplets discharged through the discharge hole to the diameter (d) of the discharge holes 3.5 to 6 to the treatment liquid flowing through the passage.

8. The apparatus of claim 6, wherein the diameter of the discharge hole is 2 micrometers to 8 micrometers.

9. The nozzle of claim 6, wherein the treatment liquid flowing through the passage and the discharge hole has a form of laminar flows.

10. The apparatus of claim 6, wherein the treatment liquid has a viscosity and a density that makes the Reynold's number 700 or less while being discharged through the discharge hole.

11. A method for treating a substrate, the method comprising:
applying a frequency to a treatment liquid flowing through a body such that the treatment liquid is supplied to the substrate in a state of droplets through a discharge hole formed in the body,
wherein an average diameter of the droplets discharged through the discharge hole is equal to or greater than 5 micrometers and is less than 15 micrometers.

12. The method of claim 11, wherein the piezoelectric element applies a frequency that makes a ratio (λ/d) of a distance (λ) between droplets discharged through the discharge hole to the diameter (d) of the discharge holes 3.5 to 6 to the treatment liquid flowing through the passage.

13. The method of claim 11, wherein the diameter of the discharge hole is 2 micrometers to 8 micrometers.

14. The method of claim 11, wherein the treatment liquid flowing through the passage and the discharge hole has a form of laminar flows.

15. The method of claim 11, wherein the treatment liquid has a viscosity and a density that makes the Reynold's number 700 or less while being discharged through the discharge hole.
